(19) United States
(12) Patent Application Publication
(10) Pub. No.: US 2011/0075752 A1
(43) Pub. Date: Mar. 31, 2011

(54) NON-UNITARY PRECODING SCHEME FOR WIRELESS COMMUNICATIONS

(76) Inventors: Hongming Zheng, Beijing (CN); Shanshan Zheng, Beijing (CN); Guangjie Li, Beijing (CN); Feng Z. Zhou, Beijing (CN)

(21) Appl. No.: 12/567,220

(22) Filed: Sep. 25, 2009

(51) Int. Cl. H04B 7/02

(52) U.S. Cl. 375/267

(57) ABSTRACT

Techniques for a non-unitary precoding scheme for wireless communications are described. An apparatus may comprise a mobile device for a mobile broadband communications system utilizing an orthogonal frequency-division multiple access technique. The mobile device may have a channel state information module operative to generate channel state information for a fixed device using a non-unitary precoding scheme for a closed loop multi-user multiple-input and multiple-output scheme. The channel state information may comprise channel quality information and a codeword index. Other embodiments are described and claimed.

### BACKGROUND

Multiple-Input Multiple-Output (MIMO) is a promising technology designed to improve system performance for next generation wireless communications. When a MIMO system uses Spatial Division Multiplexing (SDM) of multiple modulation symbol streams to a single user using the same time/frequency resource, it is referred to as a Single-User MIMO (SU-MIMO) system. When a MIMO system uses SDM of multiple modulation symbol streams to different users using the same time/frequency resource, it is referred to as a Multi-User MIMO (MU-MIMO) system.

MU-MIMO has been of particular interest due to its strength of benefiting from both multi-user diversity and spatial diversity. Further, MU-MIMO can provide larger cell throughput than SU-MIMO by exploiting channel state information at the transmitter. Channel state information at the base station is therefore important to enhance MU-MIMO performance. It is with respect to these and other considerations that the present improvements have been needed.

### BRIEF DESCRIPTION OF THE DRAWINGS

FIG. 1 illustrates one embodiment of a communications system.

FIG. 2 illustrates one embodiment of a first MIMO architecture.

FIG. 3 illustrates one embodiment of a channel state information module.

FIG. 4 illustrates one embodiment of a second MIMO architecture.

FIG. 5 illustrates one embodiment of a first MIMO frame scheme.

FIG. 6 illustrates one embodiment of a second MIMO frame scheme.

FIG. 7 illustrates one embodiment of a first logic flow.

FIG. 8 illustrates one embodiment of a second logic flow.

### DETAILED DESCRIPTION

Various embodiments may be generally directed to communication techniques for a wireless communications network, such as a mobile broadband communications system. Some embodiments may be particularly directed to enhanced techniques for a non-unitary precoding scheme for a closed loop MU-MIMO scheme (NUP-MU-MIMO).

The Internet is leaping towards mobile applications. This evolution is demanding ubiquitous communications at high data rates. Mobile broadband communications systems utilizing orthogonal frequency-division multiplexing (OFDM) and orthogonal frequency-division multiple access (OFDMA) techniques are emerging as one of the dominant technologies to fulfill high data rate demands.

Mobile broadband communications systems implementing MU-MIMO has been of particular interest due to its strength of benefiting from both multi-user diversity and spatial diversity. Further, MU-MIMO can provide larger cell throughput relative to SU-MIMO by exploiting channel state information at the transmitter. To realize these and other advantages, however, channel state information is needed at the base station to properly serve spatially multiplexed users. This need provides a significant burden on uplink capacity for many systems. Furthermore, MU-MIMO utilizes a scheduling algorithm to select groups of users that will be served simultaneously. Complexity for a given scheduling algorithm is dependent upon design choices for precoding, decoding and channel state feedback techniques implemented for a given system. In addition, mobility provides an extra dimension of complexity. For instance, mobile devices in a fading environment encounter varying degrees of degradation in the form of Doppler frequency shift and/or spectral broadening.

To solve these and other problems, various embodiments are directed to a NUP-MU-MIMO scheme which is based on the short-term channel state information (CSI) and long-term CSI. The NUP-MU-MIMO scheme includes channel quality information (CQI) calculation from non-unitary precoding (e.g., from channel inversion over the paired channel matrix), codebook quantization, user scheduling, link adaptation and detection, and so forth. The NUP-MU-MIMO scheme provides an explicit performance gain compared with a SU-MIMO scheme. Further, the NUP-MU-MIMO scheme reduces feedback overhead, feedback delay and complexity.

Some embodiments are directed to mobile devices. One embodiment, for example, is directed to a mobile device (e.g., a mobile subscriber station) for a mobile broadband communications system utilizing an OFDMA technique. The mobile device includes a channel state information module operative to generate CSI for a fixed device (e.g., a base station or access point) using a non-unitary precoding scheme for a closed loop multi-user multiple-input and multiple-output (MIMO) scheme. The CSI may comprise, for example, CQI and a codeword index (CWI). The CWI may be an index for a quantized codebook, for example.

In various embodiments, one or more mobile devices may generate channel state information for a fixed device, such as a base station (BS) or access point (AP). Channel state information is information about the current value of H, a mathematical value which represents a signal channel. It forms part of the signal model in wireless communications, the full equation of which is shown in Equation (1) as follows:

R=HX+N, Equation (1)

where R is the received signal, X is the transmitted signal, N is the noise, and H is the channel. The values R, X, N, H are usually not constant. The system usually needs to have some information regarding H to figure out what was sent from the transmitter or to enhance system performance, such as increasing transmission speed. The information can be the current value of H, or the covariance of H. This type of information is generally referred as channel state information (CSI) and is usually estimated. Typically a current value of H (e.g., instantaneous channel matrix information) is referred as short-term CSI, while higher order statistics of H (e.g., channel correlation matrix information) are referred as long-term CSI.

In one embodiment, one or more mobile devices generate short-term CSI. For instance, a mobile device may utilize instantaneous channel matrix information from a channel matrix (H) to determine precoding vectors. This may be suitable for use scenarios involving lower mobility environments for a mobile device, where a speed and/or velocity for the mobile device is approximately between 0 to 30 km/hr, for example. However, embodiments are not limited to this range.

In one embodiment, one or more mobile devices generate long-term CSI. For instance, a mobile device may utilize secondary statistical information from the channel matrix (H), such as channel correlation matrix (R) information, to determine precoding vectors. This may be suitable for use scenarios involving higher mobility environments for a mobile device, where a speed and/or velocity for the mobile device is approximately between 30 km/hr to 120 km/hr, for example. However, embodiments are not limited to this range.

Various embodiments may utilize a full or partial channel state feedback technique for short-term CSI and long-term CSI. Some embodiments utilize partial feedback to reduce overhead and complexity. In one embodiment, a partial feedback technique includes transmitting CQI and a CWI for a quantized codebook from a mobile device to a fixed device. Additionally or alternatively, other feedback techniques may be used as well. For instance, channel sounding can also be used to provide feedback information from a mobile device. The embodiments are not limited in this context.

Some embodiments are directed to fixed devices. One embodiment, for example, is directed to a fixed device for a mobile broadband communications system utilizing an OFDMA technique. The fixed device may have a precoding module operative to generate one or more precoding vectors for multiple mobile devices using a non-unitary precoding scheme for a closed loop multi-user multiple-input and multiple-output (MIMO) scheme. The precoding module may generate the one or more precoding vectors using CSI comprising CQI and a CWI received from each of the multiple mobile devices. The fixed device may also utilize the CQI and CWI from the various mobile devices to perform scheduling operations, link adaptation operations, and other operations useful for MU-MIMO schemes.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

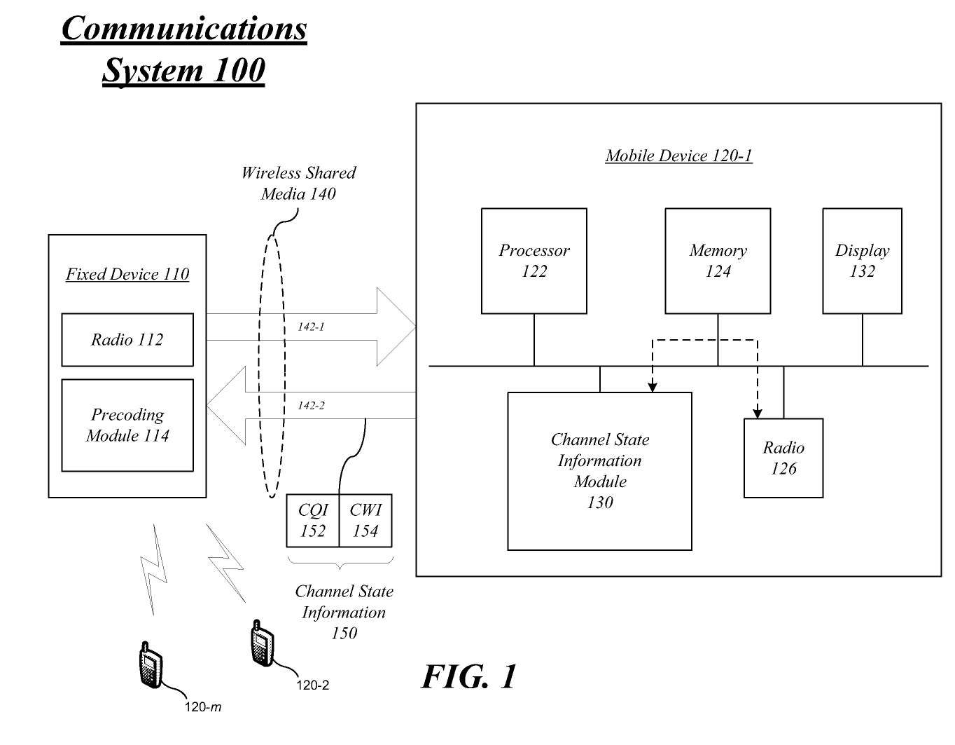

FIG. 1 illustrates a block diagram of one embodiment of a communications system 100. In various embodiments, the communications system 100 may comprise multiple nodes. A node generally may comprise any physical or logical entity for communicating information in the communications system 100 and may be implemented as hardware, software, or any combination thereof, as desired for a given set of design parameters or performance constraints. Although FIG. 1 may show a limited number of nodes by way of example, it can be appreciated that more or less nodes may be employed for a given implementation.

In various embodiments, the communications system 100 may comprise, or form part of a wired communications system, a wireless communications system, or a combination of both. For example, the communications system 100 may include one or more nodes arranged to communicate information over one or more types of wired communication links. Examples of a wired communication link, may include, without limitation, a wire, cable, bus, printed circuit board (PCB), Ethernet connection, peer-to-peer (P2P) connection, backplane, switch fabric, semiconductor material, twisted-pair wire, co-axial cable, fiber optic connection, and so forth. The communications system 100 also may include one or more nodes arranged to communicate information over one or more types of wireless communication links, such as wireless shared media 140. Examples of a wireless communication link may include, without limitation, a radio channel, infrared channel, radio-frequency (RF) channel, Wireless Fidelity (WiFi) channel, a portion of the RF spectrum, and/or one or more licensed or license-free frequency bands. In the latter case, the wireless nodes may include one more wireless interfaces and/or components for wireless communication, such as one or more transmitters, receivers, transmitter/receivers (“transceivers”), radios, chipsets, amplifiers, filters, control logic, network interface cards (NICs), antennas, antenna arrays, and so forth. Examples of an antenna may include, without limitation, an internal antenna, an omni-directional antenna, a monopole antenna, a dipole antenna, an end fed antenna, a circularly polarized antenna, a micro-strip antenna, a diversity antenna, a dual antenna, an antenna array, and so forth. In one embodiment, certain devices may include antenna arrays of multiple antennas to implement various adaptive antenna techniques and spatial diversity techniques.

As shown in the illustrated embodiment of FIG. 1, the communications system 100 comprises multiple elements, such as a fixed device 110 and a set of mobile devices 120-1-m, all of which communicate via wireless shared media 140. The fixed device may further include a radio 112 and a precoding module 114. As shown by the mobile device 120-1, the mobile devices 120-1-m may further include a processor 122, a memory unit 124, a channel state information module 130, and a radio 126. The embodiments, however, are not limited to the elements shown in FIG. 1

In various embodiments, the communications system 100 may comprise or be implemented as a mobile broadband communications system. Examples of mobile broadband communications systems include without limitation systems compliant with various Institute of Electrical and Electronics Engineers (IEEE) standards, such as the IEEE 802.11 standards for Wireless Local Area Networks (WLANs) and variants, the IEEE 802.16 standards for Wireless Metropolitan Area Networks (WMANs) and variants, and the IEEE 802.20 or Mobile Broadband Wireless Access (MBWA) standards and variants, among others. In one embodiment, for example, the communications system 100 may be implemented in accordance with the Worldwide Interoperability for Microwave Access (WiMAX) or WiMAX II standard. WiMAX is a wireless broadband technology based on the IEEE 802.16 standard of which IEEE 802.16-2004 and the 802.16e amendment (802.16e-2005) are Physical (PHY) layer specifications. WiMAX II is an advanced Fourth Generation (4G) system based on the IEEE 802.16j and IEEE 802.16m proposed standards for International Mobile Telecommunications (IMT) Advanced 4G series of standards. Although some embodiments may describe the communications system 100 as a WiMAX or WiMAX II system or standards by way of example and not limitation, it may be appreciated that the communications system 100 may be implemented as various other types of mobile broadband communications systems and standards, such as a Universal Mobile Telecommunications System (UMTS) system series of standards and variants, a Code Division Multiple Access (CDMA) 2000 system series of standards and variants (e.g., CDMA2000 1xRTT, CDMA2000 EV-DO, CDMA EV-DV, and so forth), a High Performance Radio Metropolitan Area Network (HIPERMAN) system series of standards as created by the European Telecommunications Standards Institute (ETSI) Broadband Radio Access Networks (BRAN) and variants, a Wireless Broadband (WiBro) system series of standards and variants, a Global System for Mobile communications (GSM) with General Packet Radio Service (GPRS) system (GSM/GPRS) series of standards and variants, an Enhanced Data Rates for Global Evolution (EDGE) system series of standards and variants, a High Speed Downlink Packet Access (HSDPA) system series of standards and variants, a High Speed Orthogonal Frequency-Division Multiplexing (OFDM) Packet Access (HSOPA) system series of standards and variants, a High-Speed Uplink Packet Access (HSUPA) system series of standards and variants, and so forth. The embodiments are not limited in this context.

In various embodiments, the communications system 100 may comprise a fixed device 110 having wireless capabilities. A fixed device may comprise a generalized equipment set providing connectivity, management, or control of another wireless device, such as one or more mobile devices. Examples for the fixed device 110 may include a wireless access point (AP), base station or node B, router, switch, hub, gateway, and so forth. In one embodiment, for example, the fixed device may comprise a base station or node B for a cellular radiotelephone system or mobile broadband communications system. The fixed device 110 may also provide access to a network (not shown). The network may comprise, for example, a packet network such as the Internet, a corporate or enterprise network, a voice network such as the Public Switched Telephone Network (PSTN), and so forth. Although some embodiments may be described with the fixed device 110 implemented as a base station or node B by way of example, it may be appreciated that other embodiments may be implemented using other wireless devices as well. The embodiments are not limited in this context.

In various embodiments, the communications system 100 may comprise a set of mobile devices 120-1-m having wireless capabilities. The mobile devices 120-1-m may comprise a generalized equipment set providing connectivity to other wireless devices, such as other mobile devices or fixed devices (e.g., fixed device 110). Examples for the mobile devices 120-1-m may include without limitation a computer, server, workstation, notebook computer, handheld computer, telephone, cellular telephone, personal digital assistant (PDA), combination cellular telephone and PDA, and so forth. In one embodiment, for example, the mobile devices 120-1-m may be implemented as mobile subscriber stations (MSS) for a WMAN. Although some embodiments may be described with the mobile devices 120-1-m implemented as a MSS by way of example, it may be appreciated that other embodiments may be implemented using other wireless devices as well. The embodiments are not limited in this context.

As shown by the mobile device 120-1, the mobile devices 120-1-m may comprise a processor 122. The processor 122 may be implemented as any processor, such as a complex instruction set computer (CISC) microprocessor, a reduced instruction set computing (RISC) microprocessor, a very long instruction word (VLIW) microprocessor, a processor implementing a combination of instruction sets, or other processor device. In one embodiment, for example, the processor 122 may be implemented as a general purpose processor, such as a processor made by Intel® Corporation, Santa Clara, Calif. The processor 122 may also be implemented as a dedicated processor, such as a controller, microcontroller, embedded processor, a digital signal processor (DSP), a network processor, a media processor, an input/output (I/O) processor, and so forth. The embodiments are not limited in this context.

As further shown by the mobile device 120-1, the mobile devices 120-1-m may comprise a memory unit 124. The memory 124 may comprise any machine-readable or computer-readable media capable of storing data, including both volatile and non-volatile memory. For example, the memory 124 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of the memory 124 may be included on the same integrated circuit as the processor 122, or alternatively some portion or all of the memory 124 may be disposed on an integrated circuit or other medium, for example a hard disk drive, that is external to the integrated circuit of the processor 122. The embodiments are not limited in this context.

As further shown by the mobile device 120-1, the mobile devices 120-1-m may comprise a display 132. Display 132 may comprise any suitable display unit for displaying information appropriate for a mobile computing device. In addition, display 132 may be implemented as an additional I/O device, such as a touch screen, touch panel, touch screen panel, and so forth. Touch screens are display overlays which are implemented using one of several different techniques, such as pressure-sensitive (resistive) techniques, electrically-sensitive (capacitive) techniques, acoustically-sensitive (surface acoustic wave) techniques, photo-sensitive (infra-red) techniques, and so forth. The effect of such overlays allows a display to be used as an input device, to remove or enhance the keyboard and/or the mouse as the primary input device for interacting with content provided on display 132.

In one embodiment, for example, display 132 may be implemented by a liquid crystal display (LCD) or other type of suitable visual interface. Display 132 may comprise, for example, a touch-sensitive color (e.g., 56-bit color) display screen. In various implementations, the display 132 may comprise one or more thin-film transistors (TFT) LCD including embedded transistors. In such implementations, the display 132 may comprise a transistor for each pixel to implement an active matrix. While the embodiments are not limited in this context, an active matrix display is desirable since it requires lower current to trigger pixel illumination and is more responsive to change than a passive matrix.

In various embodiments, the devices 110, 120 may communicate information over wireless shared media 140 via respective radios 112, 126. The wireless shared media 140 may comprise one or more allocations of RF spectrum. The allocations of RF spectrum may be contiguous or non-contiguous. In some embodiments, the radios 112, 126 may communicate information over the wireless shared media 140 using various multicarrier techniques utilized by, for example, WiMAX or WiMAX II systems. For example, the radios 112, 126 may utilize various MU-MIMO techniques to perform beam forming, spatial diversity or frequency diversity.

In general operation, the radios 112, 126 may communicate information using one or more communications channels, such as communications channels 142-1-p. A communication channel may be a defined set of frequencies, time slots, codes, or combinations thereof. In one embodiment, for example, the transmitting portion of the radio 112 of the fixed device 110 may communicate media and control information to the receiving portion of the radio 126 of the mobile devices 120-1-m using the communications channel 142-1, sometimes referred to as a “downlink channel.” In one embodiment, for example, the transmitting portion of the radio 126 of the mobile device 110 may communicate media and control information to the receiving portion of the radio 112 of the fixed device 110 using the communications channel 142-2, sometimes referred to as an “uplink channel.” In some cases, the communications channels 142-1, 142-2 may use the same or different set of transmit and/or receive frequencies, depending upon a given implementation.

Since the communications system 100 is a mobile broadband communications system, it is designed to maintain communications operations even when a mobile device 120-1-m is moving. Slower movement of the mobile devices 120-1-m, such as when an operator is walking, causes relatively minor degradation of communications signals due to the actual movement and is easily corrected. Faster movement of the mobile devices 120-1-m, such as when an operator is in a moving vehicle, however, may cause major degradation of communications signals due to frequency shifts. An example of such frequency shifts may be Doppler frequency shifts caused by the Doppler effect.

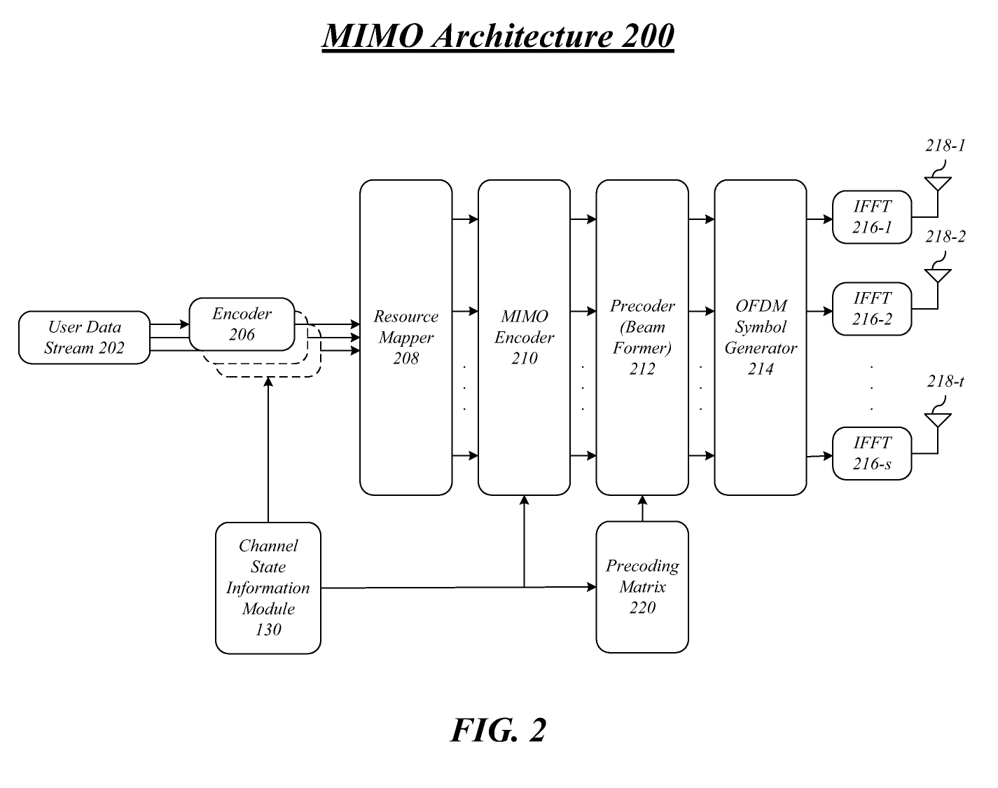

One or more of the mobile devices 120-1-m may implement a channel state feedback technique to provide CSI to the fixed device 110 for a NUP-MU-MIMO scheme. In the illustrated embodiment shown in FIG. 1, the mobile device 120-1 includes a CSI module 130 operative to generate CSI 150 for the fixed device 110. The CSI 150 may comprise, for example, CQI 152 and CWI 154. The embodiments, however, are not limited to these examples of CSI 150. The operations of the mobile devices 120-1-m in general, and the CSI module 130 in particular, may be described in more detail with reference to FIG. 2.

FIG. 2 illustrates one embodiment of a MIMO architecture 200. The MIMO architecture 200 may be implemented as part of the mobile devices 120-1-m. Although a specific number of elements are shown as part of the MIMO architecture 200, it may be appreciated that more or less elements for the MIMO architecture 200 may be used for a given implementation, and the embodiments are not limited in this context.

In the illustrated embodiment shown in FIG. 2, the MIMO architecture 200 comprises one or more encoders 206, a resource mapper 208, a MIMO encoder 210, a precoder (beam former) 212 (hereinafter referred to as “precoder 212”), an OFDM symbol generator 214, and one or more inverse Fast Fourier Transform (IFFT) blocks 216-1-s for a transmitter, and one or more antennas 218-1-t. Each encoder 206 contains a channel encoder, interleaver, rate-matcher and modulator for each layer. The resource mapper 208 maps modulated symbols to corresponding time-frequency resources in allocated resource units (RUs). The MIMO encoder 210 maps L (≧1) layers onto Nₛ (≧1) streams, which are fed to the precoder 212. The precoder 212 maps user data stream 202 to antennas 218-1-t by generating the antenna-specific data symbols according to a selected MIMO mode (e.g., open-loop or closed-loop) utilizing the precoding matrix 220. The OFDM symbol generator 214 maps antenna-specific data to an OFDM symbol.

The MIMO architecture 200 may further comprise the CSI module 130. The CSI module 130 may be arranged to generate CSI 150 for the fixed device 110. In one embodiment, the CSI module 130 may implement a partial feedback technique. For instance, the CSI module 130 may feedback CSI 150 in the form of CQI 152 and CWI 154. The CSI module 130 may generate the CSI 150 as short-term CSI or long-term CSI based on a determined speed and/or velocity for the mobile devices 120-1-m. A speed and/or velocity for the mobile devices 120-1-m may be determined or calculated by any number of conventional techniques.

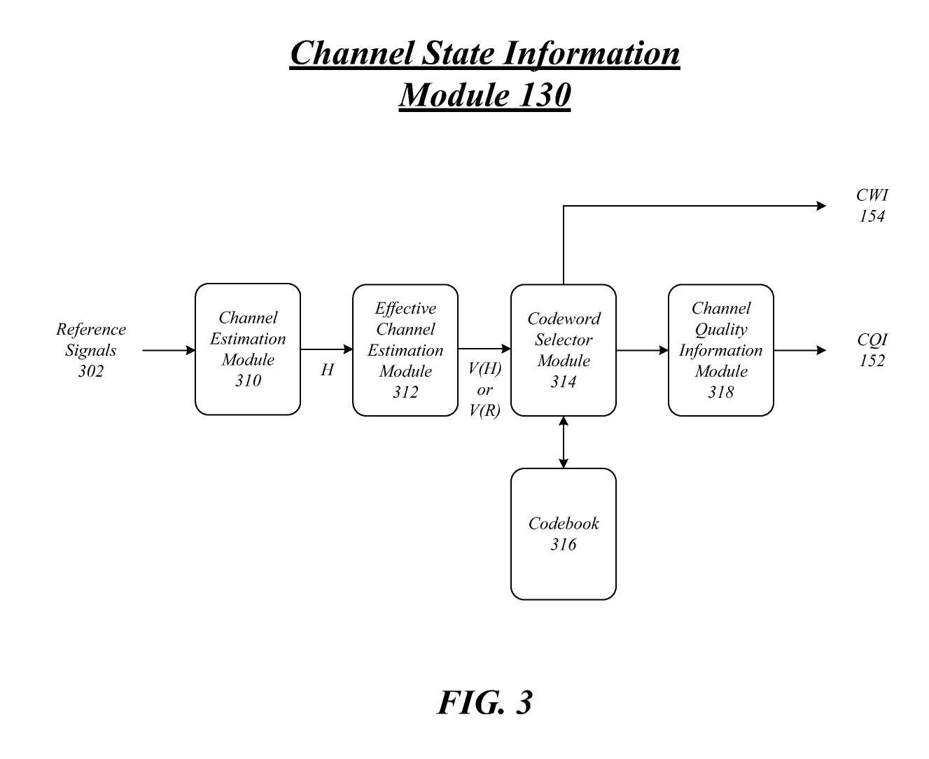

FIG. 3 illustrates one embodiment of the CSI module 130. In the illustrated embodiment shown in FIG. 3, the CSI module 130 may comprise a channel estimation module 310, an effective channel estimation module 312, a codeword selector module 314, a codebook 316, and a CQI module 318. Although a specific number of elements are shown as part of the CSI module 130, it may be appreciated that more or less elements for the CSI module 130 may be used for a given implementation, and the embodiments are not limited in this context.

In various embodiments, one or more mobile devices 120-1-m may utilize the CSI module 130 to generate CSI 150 for the fixed device 110. CSI is information about the current value of H, a mathematical value which represents a signal channel. The system usually needs to have some information regarding H to figure out what was sent from the transmitter or to enhance system performance, such as increasing transmission speed. Usually a current value of H (e.g., instantaneous channel matrix information) is referred as short-term CSI, while higher order statistics of H (e.g., channel correlation matrix information) are referred as long-term CSI.

The channel estimation module 310 for the CSI module 130 may be arranged to receive one or more reference signals 302 over a downlink wireless channel from the fixed device 110 via the radio 126. The reference signals 302 may comprise, for example, pilot signals, preambles, midambles, carriers, subcarriers, and so forth. The channel estimation module 310 may estimate a channel matrix based on the one or more reference signals 302. In one embodiment, for example, the channel matrix may comprise an instantaneous channel matrix (H) for short-term CSI in lower mobility environments. In one embodiment, for example, the channel matrix may comprise a channel correlation matrix (R) for long-term CSI in higher mobility environments.

Mobile Device: Short-Term CSI

In one embodiment, the CSI module 130 generates short-term CSI. For instance, the CSI module 130 may utilize instantaneous channel matrix information from a channel matrix (H) to determine precoding vectors. This may be suitable for use scenarios involving lower mobility environments for a mobile device, where a speed for the mobile device is approximately between 0 to 30 km/hr, for example. However, embodiments are not limited to this range.

For lower mobility environments, the channel estimation module 310 may estimate a channel matrix (H) based on the reference signals 302. The channel matrix (H) may comprise, for example, a Nᵣ×Nₜ matrix where Nᵣ represents a number of receive antennas and Nₜ represents a number of transmit antennas.

The effective channel estimation module 312 may be arranged to determine an effective channel based on the channel matrix (H). Based on the estimated channel matrix (H), the effective channel estimation module 312 calculates an effective channel V(H). In one embodiment, for example, the effective channel estimation module 312 may be arranged to determine the effective channel V(H) using singular value decomposition (SVD). For instance, the effective channel estimation module 312 performs SVD as shown in Equation (2) as follows:

[U S V]=SVD(H). Equation (2)

The effective channel estimation module 312 may then select a maximal right singular vector as the effective channel V(H), as shown in Equation (3) as follows:

H_{eff}=V(1,:). Equation (3)

Based on the effective channel V(H), the codeword selector module 314 may quantize the effective channel V(H) using a quantized codebook 316. Codebook based precoding is an advantageous technique for closed-loop MIMO systems due to the reason of limited feedback overhead. The quantized codebook 316 may be implemented using any known codebook techniques. For example, the quantized codebook 316 may comprise a power balanced codebook or power unbalanced codebook. An example of a power balanced codebook is a DFT based codebook, which provides better performance for a spatially correlated channel. An example of a power unbalanced codebook is an antenna selection based codebook, which provides better performance for an uncorrelated channel. Examples for the quantized codebook 316 may include without limitation an IEEE.16e 6-bit codebook, a phase-adapted DFT 5-bit codebook, a 3GPP LTE 4-bit codebook, an IEEE 802.16e 3-bit codebook, a DFT+AS 5-bit codebook, and others as well. The embodiments are not limited in this context.

The codeword selector module 314 may perform quantization by selecting a codeword from the quantized codebook 316 for the effective channel V(H). This may be performed through correlation. In one embodiment, the codeword selector module 314 may select a codeword from the quantized codebook 316 that has a maximal correlation value to the effective channel V(H). For instance, the codeword selector module 314 may quantize the effective channel V(H) and select the codeword from a given codebook C as shown in Equation (4) as follows:

$$v = {c}_{n} \\ n = {arg max}_{{C}_{i} ∈ C} ( {H}_{eff} {c}_{i} ) , \qquad Equation ( 4 )$$

where Cᵢ is the i^{th} code word and i^{th} column of the quantized codebook 316. The codeword selector module 314 then outputs the selected codeword or the CWI 154 to the CQI module 318.

The CQI module 318 may be arranged to estimate CQI 152 based on the selected codeword as represented by the CWI 154. Examples for the CQI 152 may include without limitation channel gain, a physical signal-to-interference-and-noise ratio (SINR) or carrier-to-interference-and-noise ratio (CINR) (both collectively referred to as “SINR”), effective SINR, frequency offset estimation, band selection and so forth. The embodiments are not limited in this context.

In one embodiment, for example, the CQI module 318 may be arranged to estimate the CQI 152 without any a priori knowledge of precoding vectors used by other mobile devices. This may significantly reduce the amount of signaling traffic for the uplink wireless channel 142-2.

In one embodiment, the CQI module 318 estimates CQI 152 as a physical signal-to-interference-and-noise ratio (SINR) of a minimum mean square error (MMSE) receiver (e.g., radio 126) by assuming the selected codeword is a precoding vector for a given mobile device and a set of precoding vectors for all other active mobile devices are orthogonal to the precoding vector. For instance, the CQI module 318 may begin calculations for a post-SINR for a MMSE receiver with the assumption that the selected codeword is its precoding vector and the precoding vectors for other mobile devices are orthogonal to its precoding vector, which is shown in Equations (5) as follows:

v̅=[ν,null(ν)]^{H}

ω=((H v̅)^{H}(H v̅)+I·noise)⁻¹·(H v̅)^{H}

E= ω̅(H v̅)

I_{int erf}=E−diag(E), Intf=diag(I_{int erf}·I_{int erf}^{H}),

S=∥diag(E)∥²,

Intf+N=(noise)·(ω·ω^{H})+Intf

SINR=S/(Intf+N) Equations (5)
where ν is the selected code word index;
where v̅ is the emulated precoding vector for a mobile device assuming the other mobile devices will use an orthogonal precoding vector over the mobile device;
where ω is the MMSE filter coefficient when a MMSE receiver is used;
where I_{int erf} is the interference between the different streams within a given pairing of mobile stations;
where S is the signal power after detection; and
where I is the Nr-by-Nr identical matrix and noise is the noise power.

The CQI module 318 then takes the first element of the SINR vector as the CQI, which is shown in Equation (6) as follows:

CQI=SINR(1) Equation (6)

Once the codeword selector module 314 and the CQI module 318 generate the respective CQI 152 and the CWI 154, the radio 126 transmits the CQI 152 and the CWI 154 over the uplink wireless channel 142-2 to the fixed device 110.

Mobile Device—Long-Term CSI

In one embodiment, the CSI module 130 generates long-term CSI. For instance, the CSI module 130 may utilize secondary statistical information from the channel matrix (H), such as channel correlation matrix (R) information, to determine precoding vectors. This may be suitable for use scenarios involving higher mobility environments for a mobile device, where a speed for the mobile device is approximately between 30 km/hr to 120 km/hr, for example. However, embodiments are not limited to this range.

Most of the elements described with reference to short-term CSI are also applicable to long-term CSI for a NUP-MU-MIMO scheme. One difference is how the codebook vector is mapped. The short-term CSI is based on the instantaneous channel matrix information from a channel matrix (H). The codebook vector V(H) is then mapped from the right singular vector of channel H over the quantized codebook 316. The long-term CSI, however, is based on the secondary statistical information, for example, channel correlation matrix (R). The effective channel estimation module 312 calculates V(R) as the right singular vector of channel correlation matrix (R) information, rather than the instantaneous channel matrix information.

A suitable use scenario for long-term CSI is higher mobility environments. Due to significant amounts of delay and variance caused by higher vehicle speed, link adaptation will need to be robust. Embodiments use a distributed permutation for resource allocation for link adaptation because under the distributed permutation CQI will be averaged over an entire band and/or several bands which are not frequency dependent and therefore less sensitive to CQI delay and time variations from higher speeds. Under a distributed permutation the channel correlation matrix (R) can be calculated as shown in Equation (7) as follows:

$$R = {\sum }_{i} ( {H}_{i}^{H} {H}_{i} ) \qquad Equation ( 7 )$$

where the subscript i denotes the subchannel, subcarrier, or subband index. Also the channel correlation matrix (R) could be averaged in the time domain (except in the relevant frequency) to increase accuracy and performance.

Further, the channel correlation matrix (R) depends on position information for a mobile device 120-1-m, such as angle of departure (AOD) information, for example. In general the position information can be used to approximately determine the channel correlation matrix (R), as shown in Equation (8) as follows:

R=f(AOD) Equation (8)

As such, embodiments do not need to calculate the channel correlation matrix (R) from each frame, symbol, subchannel, or subcarrier as in conventional solutions.

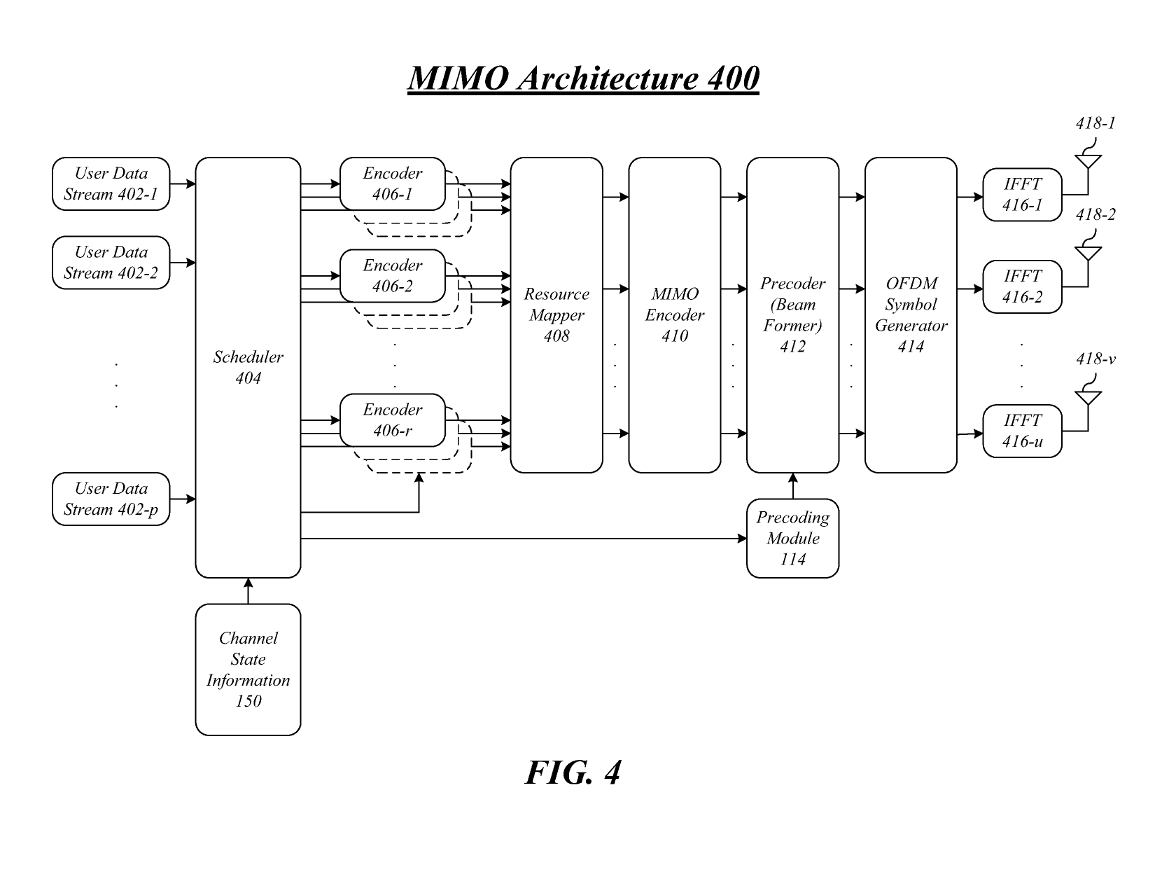

After the channel correlation matrix (R) is determined, a SVD operation is used to calculate the right singular vector V(R) for codebook mapping. All other procedures for long-term CSI performed by the mobile devices 120-1-m are substantially the same as for short-term CSI, including CQI estimation, codebook mapping, and feedback of CQI 152 and CWI 154. Similarly, all other procedures for long-term CSI performed by the fixed device 110 (as described below with reference to FIG. 4) are substantially the same as for short-term CSI, including user pairing/or scheduling, precoding vector (weight) calculation (e.g., channel inversion or zero forcing or MMSE based) based on feedback codeword indices from multiple mobile devices 120-1-m, CQI updating, modulation and modulation and coding scheme (MCS) selection, and final precoding for the mobile devices 120-1-m.

It is worthy to note that the feedback frequency for long-term CSI based NUP-MU-MIMO is significantly lower than short-term CSI based NUP-MU-MIMO, which substantially reduces feedback overhead. Further, CQI 152 is robust for link adaptation even when the mobile devices 120-1-m are operating in a higher mobility environment.

Fixed Device

FIG. 4 illustrates one embodiment of a MIMO architecture 400. The MIMO architecture 400 may be implemented as part of the fixed device 110. Although a specific number of elements are shown as part of the MIMO architecture 400, it may be appreciated that more or less elements for the MIMO architecture 400 may be used for a given implementation, and the embodiments are not limited in this context.

Similar to the MIMO architecture 200, the MIMO architecture 400 may include one or more encoders 406-1-R, a resource mapper 408, a MIMI encoder 410, a precoder (beam former) 412, an OFDM symbol generator 414 and one or more IFFT 416-1-u for a transmitter, and one or more antennas 418-1-V. These elements may have structure and operations substantially similar to their counterparts from the MIMO architecture 200.

In various embodiments, the MIMO architecture 400 may be implemented as part of the fixed device 110. The fixed device 110 is for a mobile broadband communications system utilizing an OFDMA technique. The fixed device 110 may include a precoding module 114. The precoding module 114 may be arranged to generate one or more precoding vectors for multiple mobile devices 120-1-m using a NUP-MU-MIMO scheme. The precoding module 114 may be arranged to generate the one or more precoding vectors using CSI 150 comprising CQI 152 and a CWI 154 received from each of the multiple mobile devices 120-1-m. In one embodiment, for example, the fixed device 110 may receive the CQI 152 and CWI 154 from multiple mobile devices 120-1-m over the uplink wireless channel 142-2 via the radio 112.

In various embodiments, the MIMO architecture 400 may include a scheduler 404. The scheduler 404 may implement a user scheduling algorithm designed to schedule groups of active mobile devices 120-1-m to resource units and decide their MCS level and MIMO parameters (e.g., MIMO mode, rank, and so forth). The scheduler 404 is responsible for making a number of decisions with regard to each resource allocation, including allocation type, SU-MIMO versus MU-MIMO, MIMO mode (e.g., open-loop or closed-loop), user grouping, rank (e.g., number of streams to be used for a mobile device 120-1-m allocated to a resource unit), MCS level per layer (e.g., modulation and coding rate to be used on each layer), boosting (e.g., power boosting values to be used on data and pilot subcarriers), and band selection.

In one embodiment, for example, the scheduler 404 may be arranged to select a group or subset of mobile devices 120-1-n from a set of active mobile devices 120-1-m, where n is less than m. The advantage of MU-MIMO is that transmissions over the downlink wireless channel 142-1 may be made to more than one mobile device 120-1-m at a time. Selecting a group or subset of mobile devices 120-1-n from the set of active mobile devices 120-1-m may be accomplished using different user scheduling algorithms, which are designed to provide multiuser diversity. Once a group is selected, the precoding module 114 may generate a precoding vector for the selected group of mobile devices 120-1-n for transmission in the MIMO downlink wireless channel 142-1 (e.g., broadcast channel).

In one embodiment, for example, the scheduler 404 may implement a “brute-force” complete search algorithm that searches over all possible combinations of mobile devices 120-1-m (e.g., users). This approach provides an advantage in that it increases probabilities of maximize throughput. A disadvantage to the brute-force approach, however, is that it requires a high degree of computational complexity. As such, another embodiment of the scheduler 404 may implement an alternative approach for lower complexity multiuser scheduling in the form of a “greedy search” user scheduling algorithm, as described further below.

In order to implement a complete search, the scheduler 404 may form multiple candidate groups of mobile devices 120-1-n from the set of mobile devices 120-1-m. The scheduler 404 may estimate a sum rate for each candidate group of mobile devices 120-1-n, and select a candidate group of mobile devices 120-1-n having a highest sum rate as the group of mobile devices 120-1-n for which precoding vectors are generated at a given time.

Once a group of mobile devices 120-1-n is selected, the precoding module 114 may generate the one or more precoding vectors for the selected group of mobile devices 120-1-n. In one embodiment, for example, the precoding module 114 may generate the one or more precoding vectors using a zero forcing (ZF) or minimum mean square error (MMSE) algorithm. The radio 112 may transmit the one or more precoding vectors to the selected group of mobile devices 120-1-n over the downlink wireless channel 142-1 using control signals or reference signals. For instance, the radio 112 may signal the precoding weights directly to the mobile devices 120-1-n, or precode the reference signals 302 with the precoding weights. The mobile devices 120-1-n may then perform a more precise channel estimation for a next transmitted frame of information.

As one example of a user scheduling algorithm that performs a complete search for group selection, the fixed device 110 may receive a CQI 152 and a CWI 154 from each active mobile device 120-1-m within transmission range of the fixed device 110. Using the multiple CQI 152 and CWI 154, the fixed device 110 may estimate a sum rate for all possible user pairs, select a user pair with a maximal sum-rate, generate precoding vectors based on ZF or MMSE algorithms, and adjust the CQI for link adaptation.

A more detailed example having 2 data streams for 2 mobile devices (or users) over MU-MIMO is provided next. Although the example utilizes 2 data streams for 2 users for purposes of clarity, it may be appreciated that the same principles may be extended to any number of data streams and users as desired for a given implementation. The embodiments are not limited in this context. The following description may utilize the term “user pair” due to the 2×2 example. However, the term “user group” may also be substituted for the term “user pair” when a number of selected users in a group is greater than 2.

In the 2×2 example, the scheduler 404 implements an enhanced user scheduling algorithm for NUP-MU-MIMO. The enhanced user scheduling algorithm may comprise, for example, a complete search user scheduling algorithm. According to the complete search user scheduling algorithm, for any i^{th} user and j^{th} user pair, a precoding vector is generated based on a channel inversion algorithm as shown in Equation (9) as follows:

W_{i,j}=C(ν)^{H}(C(ν)C(ν)^{H})⁻¹; C(ν)=[νᵢ, νⱼ]^{H} Equation (9)

The precoding vector may be normalized by each column of matrix W_{i,j} as the new precoding weight W̅_{i,j}.

The CQI 152 may then be adjusted based on a new precoding weight and feedback codebook pair, as shown in Equation (10) as follows:

[CQI′ᵢ, CQI′ⱼ]=[CQIᵢ, CQIⱼ]·diag(C(ν)· W̅_{i,j}) Equation (10)

The sum rate of any arbitrary two users may be calculated from all the active users in the system based on the assumed known channel matrix, as shown in Equation (11) as follows:

Throughput{i, j}=(det(I+ H̅_{i,j} H̅_{i,j}^{H}) Equation (11)

where H̅_{i,j}=diag(sqrt([CQI′ᵢ, CQI′ⱼ]))·C(ν)· W̅_{i,j}.

These operations may be repeated across all possible user pairings or groupings. A user pair or group with a maximal sum-rate is then selected, and a corresponding precoding vector may be generated for the selected user pair or group as shown in Equation (12) as follows:

$$User pair \text{:} \{ k , l \} = {arg max}_{\{ i , j \}} ( Throughput \{ i , j \} ) \\ Precoding vector \text{:} {\overline{W}}_{k , l} \qquad Equation ( 12 )$$

According to the updated CQI 152 for the selected user pair, e.g. [CQI′ₖ, CQI′ₗ], the fixed device 110 may choose a suitable MCS for the transmitted streams. The fixed device 110 does the precoding for the selected user pair together, and signals the precoding weight to the user pair or precodes a reference signal 302 (e.g., a precoded pilot) with a precoding weight for channel estimation by the selected mobile stations 120-1-n.

Additionally or alternatively, the scheduler 404 may be arranged to implement a greedy search user scheduling algorithm. The enhanced user scheduling algorithm described above is based on a complete search of all possible user pairs, which is suitable for cases where a limited number of active users are present in a system. The full search, however, might not be suitable for a larger number of active users in the system due to the requisite computing complexity. As such, an alternative greedy search user scheduling algorithm may be utilized to reduce computing complexity for user group selection.

To implement a greedy search user scheduling algorithm, for example, the scheduler 404 may select a first mobile device from the set of active mobile devices 120-1-m with a highest CQI or channel capacity. Assume for purposes of this example that the first mobile device is the mobile device 120-1. The scheduler 404 may form candidate groups of mobile devices 120-1-n from the set of mobile devices 120-1-m, with each candidate group having the first mobile device 120-1 and at least a second mobile device 120-2-n. The scheduler 404 then estimates a sum rate for each candidate group of mobile devices 120-1-n, which includes at least the first mobile device 120-1 and one other active mobile device, and selects a candidate group of mobile devices 120-1-n having a highest sum rate as the group of mobile devices 120-1-n for which precoding vectors are generated.

By way of a more detailed example, the scheduler 404 may implement a greedy search user scheduling algorithm for user group selection with a NUP-MU-MIMO scheme. The greedy search user scheduling algorithm begins by selecting a user with a largest feedback CQI 152, as shown in Equation (13) as follows:

$$i = {arg max}_{j} ( {CQI}_{j} ) \qquad Equation ( 13 )$$

Assume that for a first selected user i=1, for any j^{th} user j≠1, the precoding vectors are generated based on a channel inversion algorithm as shown in Equation (14) as follows:

W_{1,j}=C(ν)^{H}(C(ν)C(ν)^{H})⁻¹; C(ν)=[ν₁, νⱼ]^{H} Equation (14)

The precoding vector may b normalized by each column of matrix W_{i,j} as the new precoding weight W̅_{i,j}.

The CQI 152 may be adjusted using a new precoding weight and feedback codebook pair, as shown in Equation (15) as follows:

[CQI′₁, CQI′ⱼ]=[CQI₁, CQIⱼ]·diag(C(ν)· W̅_{1,j}) Equation (15)

The sum rate for a pair of users may be calculated as shown in Equation (16) as follows:

Throughput{1, j}=(det(I+ H̅_{1,j} H̅_{1,j}^{H}) Equation (16)

where H̅_{1,j}=diag(sqrt([CQI′₁, CQI′ⱼ]))·C(ν)· W̅_{i,j}

These operations may be repeated for each user pair. The scheduler 404 then selects the user pair having at least the first mobile device 120-1 and a second mobile device 120-2-m (e.g., assume mobile device 120-2) that provides a maximal sum rate, and a corresponding precoding vector for the selected user pair, as shown in Equation (17) as follows:

$$User pair \text{:} \{ 1 , l \} = {arg max}_{j} ( Throughput \{ 1 , j \} ) \\ Precoding vector \text{:} {\overline{W}}_{1 , l} \qquad Equation ( 17 )$$

According to the adjusted CQI 152 for the selected user, e.g., [CQI′₁, CQI′ₗ], the fixed device 110 selects a suitable MCS for the transmitted streams.

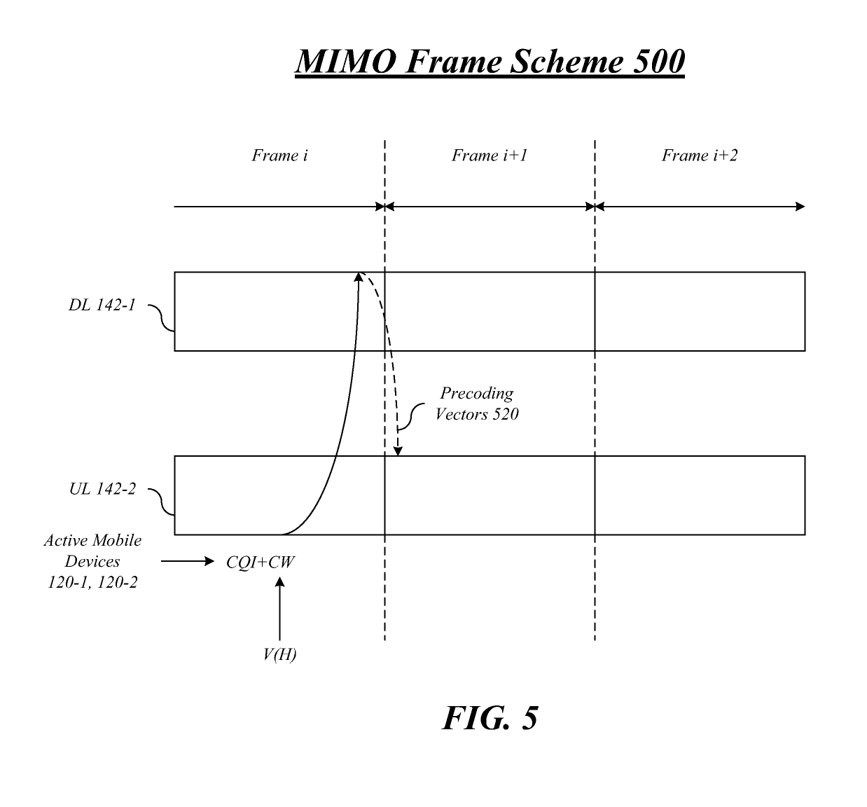

FIG. 5 illustrates one embodiment of a MIMO frame scheme 500. The MIMO frame scheme 500 represents a UNP-MU-MIMO frame scheme for use with the fixed device 110 and two or more mobile devices 120-1-m of the communications system 100. The MIMO frame scheme 500 assumes the devices 110, 120-1 and 120-2 are using short-term CSI for lower mobility environments.

In the illustrated embodiment shown in FIG. 5, for example, the fixed device 110 may send the reference signals 302 (e.g., pilot signals) over the downlink wireless channel 142-1 (or different DL channels) to the active mobile devices 120-1, 120-2 during frame i. The mobile devices 120-1, 120-2 may each include the CSI module 130 to generate the CSI 150 for the fixed device 110 using the NUP-MU-MIMO scheme, with the CSI 150 comprising the CQI 152 and the CWI 154, which are calculated using the channel matrix (H) and effective channel V(H). It is worthy to note that at this point the active mobile devices 120-1, 120-2 calculate their CQI 152 and CWI 154 without prior knowledge of each others' precoding vector. The active mobile devices 120-1, 120-2 each send the CQI 152 and the CWI 154 to the fixed device 110 over the uplink wireless channel 142-2 (or different UL channels) during the same frame i. Assuming the active mobile devices 120-1, 120-2 are selected for the same group, the fixed device 110 may include the precoding module 114 operative to generate one or more precoding vectors 520 for multiple mobile devices 120-1, 120-2 using the NUP-MU-MIMO scheme, with the precoding module 114 to generate the precoding vectors 520 using the CSI 150 comprising the CQI 152 and the CWI 154 as received from each of the multiple mobile devices 120-1, 120-2. The fixed device 110 sends the precoding vectors 520 to the active mobile devices 120-1, 120-2 over the downlink wireless channel 142-2 during the start of frame i+1, which are then used by the active mobile devices 120-1, 120-2 for future communications with the fixed device 110. It is worthy to note that the active mobile devices 120-1, 120-2 may now detect signals from the fixed device 110 using MMSE detection with knowledge of each others' precoding vector.

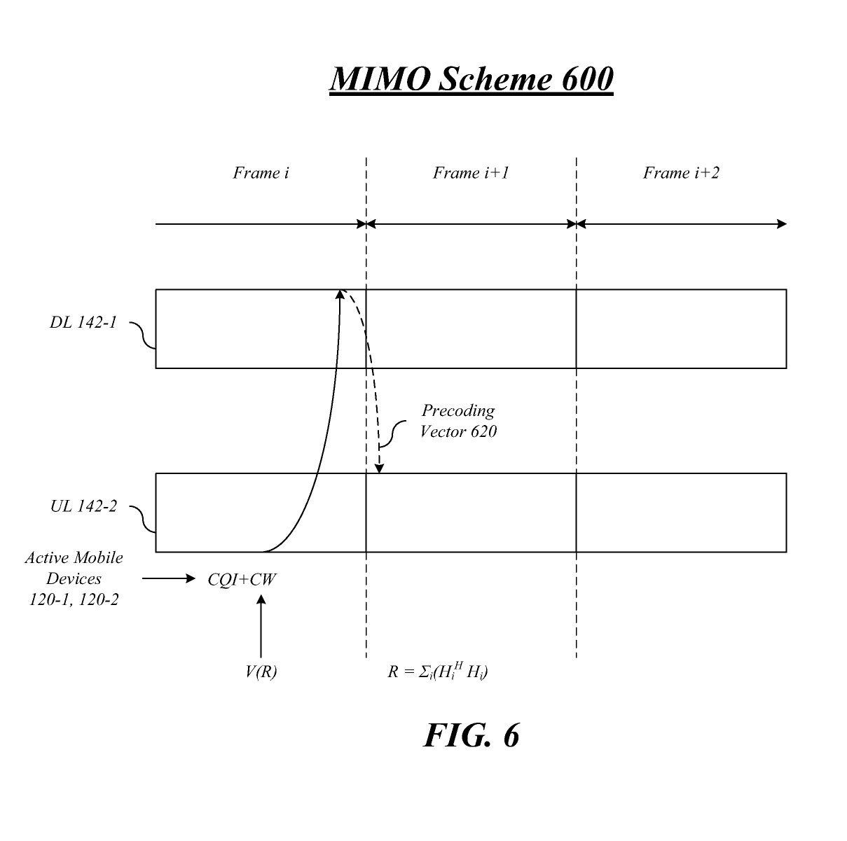

FIG. 6 illustrates one embodiment of a MIMO frame scheme 600. Similar to the MIMO frame scheme 500, the MIMO frame scheme 600 represents a UNP-MU-MIMO frame scheme for use with the fixed device 110 and two or more mobile devices 120-1-m of the communications system 100. However, the MIMO frame scheme 600 assumes the devices 110, 120-1 and 120-2 are using long-term CSI for higher mobility environments. As such, the CSI modules 130 estimate the CQI 152 and the CWI 154 utilizing the channel correlation matrix (R), and the effective channel V(R). All other operations for the mobile devices 120-1, 120-2 and the fixed device 110 are substantially similar to those described with reference to the MIMO frame scheme 500.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof. The embodiments are not limited in this context.

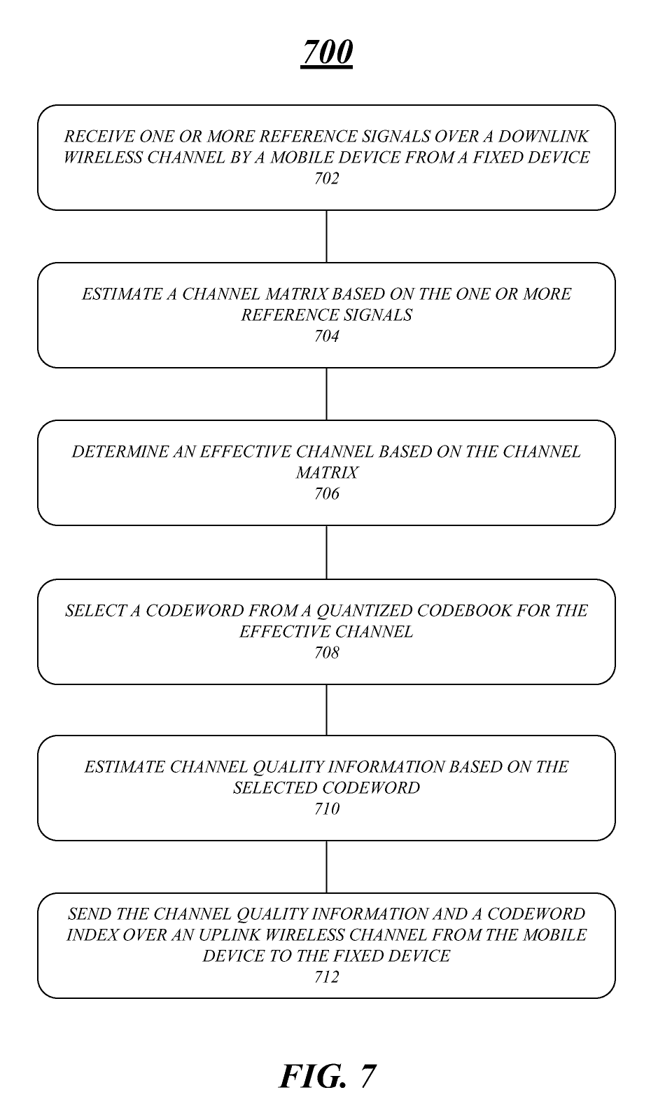

FIG. 7 illustrates one embodiment of a logic flow 700. The logic flow 700 may be representative of the operations executed by one or more embodiments described herein, such as one or both of the devices 110, 120. For instance, the logic flow 700 may be implemented by one or more of the mobile devices 120-1-m.

In one embodiment, the logic flow 700 may receive one or more reference signals over a downlink wireless channel by a mobile device from a fixed device at block 702. For example, the mobile device 120-1 may receive one or more reference signals 302 over the downlink wireless channel 142-1 from the fixed device 110.

In one embodiment, the logic flow 700 may estimate a channel matrix based on the one or more reference signals at block 704. For example, the channel estimate module 310 may estimate the channel matrix (H) based on the one or more reference signals 302, and output the channel matrix (H) to the effective channel estimation module 312.

In one embodiment, the logic flow 700 may determine an effective channel based on the channel matrix at block 706. For example, the effective channel estimation module 312 may receive the channel matrix (H) from the channel estimate module 310, and determine an effective channel based on the channel matrix (H). The effective channel estimation module 312 may determine the effective channel as V(H) or V(R) based on short-term CSI or long-term CSI, and output the decision to the codeword selector module 314. This decision may be based on a speed and/or velocity of the mobile device 120-1.

In one embodiment, the logic flow 700 may select a codeword from a quantized codebook for the effective channel at block 708. For example, the codeword selector module 314 may select a codeword from the quantized codebook 316 for the effective channel V(H) or V(R), and output the selected codeword or the CWI 154. The quantized codebook 316 may comprise any known codebook.

In one embodiment, the logic flow 700 may estimate channel quality information based on the selected codeword at block 710. For example, the CQI module 318 may receive the CWI 154 from the codeword selector module 314, and estimate CQI 152 based on the selected codeword indicated by the CWI 154.

In one embodiment, the logic flow 700 may send the channel quality information and a codeword index over an uplink wireless channel from the mobile device to the fixed device at block 712. For example, the mobile device 120-1 may send the CQI 152 and the CWI 154 over the uplink wireless channel 142-2 to the fixed device 110.

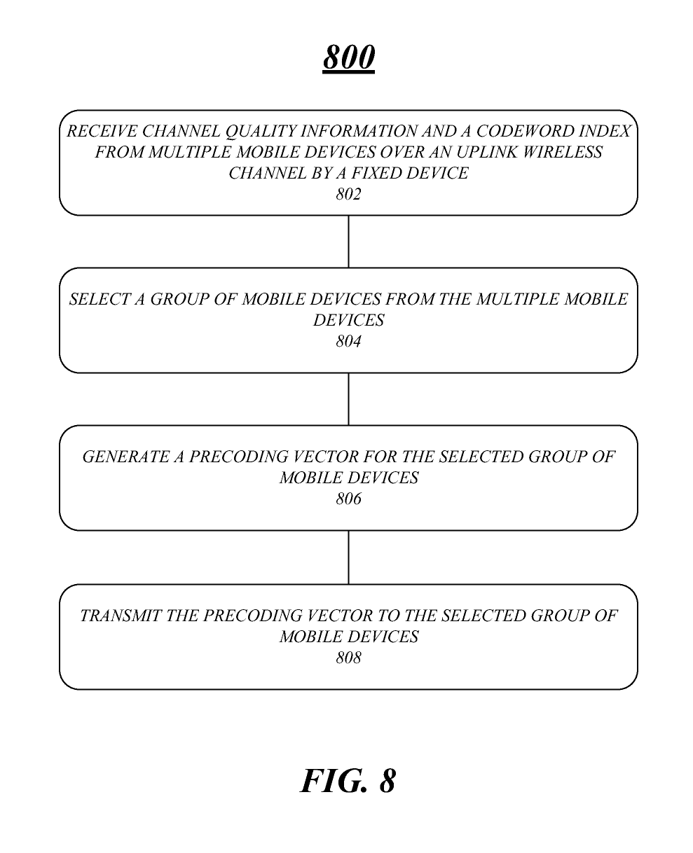

FIG. 8 illustrates one embodiment of a logic flow 800. The logic flow 800 may be representative of the operations executed by one or more embodiments described herein, such as one or both of the devices 110, 120. For instance, the logic flow 800 may be implemented by the fixed device 110.

In one embodiment, the logic flow 800 may receive channel quality information and a codeword index from multiple mobile devices over an uplink wireless channel by a fixed device at block 802. For example, the fixed device 110 may receive the CQI 152 and the CWI 154 from multiple mobile devices 120-1, 120-2 and 120-3 over the uplink wireless channel 142-2.

In one embodiment, the logic flow 800 may select a group of mobile devices from the multiple mobile devices at block 804. For example, the scheduler 404 may implement a user scheduling algorithm to select a group of mobile devices 120-1, 120-2 from the multiple mobile devices 120-1, 120-2 and 120-3. The user scheduling algorithm may comprise a complete search, a greedy search, or some other form of user scheduling algorithm.

In one embodiment, the logic flow 800 may generate a precoding vector for the selected group of mobile devices at block 806. For example, the precoding module 114 may generate the precoding vector (e.g., 520, 620) for the selected group of mobile devices 120-1, 120-2.

In one embodiment, the logic flow 800 may transmit the precoding vector to the selected group of mobile devices at block 808. For example, the fixed device 110 may use the radio 112 to transmit the precoding vector (e.g., 520, 620) to the selected group of mobile devices 120-1, 120-2 over the downlink wireless channel 142-1.

The embodiments provide significant technical advantages over conventional techniques for MU-MIMO. For example, the NUP-MU-MIMO techniques described herein go beyond a simple zero-forcing scheme for MU-MIMO. Rather, the embodiments provide a more robust CQI calculation for MCS selection in the link adaptation, CQI updating in the fixed device 110 when channel inversion is used by the fixed device 110 for multiuser pairing, and different application scenarios including lower vehicle speed and higher vehicle speed by using short-term CSI and long-term CSI feedback information. A more robust technique for CQI estimation is provided by the embodiments to assist in solving CQI mismatch problems. CQI mismatch is a significant design challenge for channel inversion implementations of MU-MIMO. CQI mismatch provides an inaccurate CQI for link adaptation, which degrades system capacity accordingly. In another example, embodiments provide enhanced user scheduling algorithms that combine feedback CQI and codebook vectors to effectively schedule the multiple users, including complete search and greedy search user scheduling algorithms. The enhanced user scheduling algorithms for user group scheduling significantly reduces complexity for a MU-MIMO system for an approximately same level of performance. In yet another example, each user needs to feedback only one CQI and one codeword index, which is much less feedback overhead compared with conventional MU-MIMO schemes. On the contrary, conventional MU-MIMO schemes typically need feedback of more than one CQI and one codeword index for user pairing. The reduced feedback requirement also lowers feedback delay (since there is only one step for feedback), which may be particularly important for time division duplexing (TDD) systems. Other technical advantages exist as well, and the embodiments are not limited to these examples.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a computer-readable medium or article which may store an instruction or a set of instructions that, if executed by a computer, may cause the computer to perform a method and/or operations in accordance with the embodiments. Such a computer may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a mobile device for a mobile broadband communications system utilizing an orthogonal frequency-division multiple access technique, the mobile device having a channel state information module operative to generate channel state information for a fixed device using a non-unitary precoding scheme for a closed loop multi-user multiple-input and multiple-output (MIMO) scheme, the channel state information comprising channel quality information and a codeword index.

2. The apparatus of claim 1, comprising:
a radio operative to receive one or more reference signals over a downlink wireless channel from the fixed device;
the channel state information module comprising:
a channel estimation module operative to estimate a channel matrix based on the one or more reference signals;
an effective channel estimation module operative to determine an effective channel based on the channel matrix;
a codeword selector module operative to select a codeword from a quantized codebook for the effective channel; and
a channel quality information module operative to estimate channel quality information based on the selected codeword.

3. The apparatus of claim 2, the radio operative to transmit the channel quality information and the codeword index over an uplink wireless channel to the fixed device.

4. The apparatus of claim 2, the channel matrix comprising an instantaneous channel matrix for short-term channel state information.

5. The apparatus of claim 2, the channel matrix comprising a channel correlation matrix for long-term channel state information.

6. The apparatus of claim 2, the effective channel estimation module operative to determine the effective channel using singular value decomposition.

7. The apparatus of claim 2, the channel quality information module operative to estimate the channel quality information without precoding vectors of other mobile devices.

8. The apparatus of claim 2, the channel quality information module operative to estimate the channel quality information as a physical signal-to-interference-and-noise ratio (SINR) of a minimum mean square error (MMSE) receiver by assuming the selected codeword is a precoding vector for the mobile device and a set of precoding vectors of other mobile devices are orthogonal to the precoding vector.

9. The apparatus of claim 2, the channel quality information comprising channel gain, a physical signal-to-interference-and-noise ratio (SINR), effective SINR, frequency offset estimation or band selection.

10. The apparatus of claim 2, the mobile device comprising a digital display.

11. An apparatus, comprising:
a fixed device for a mobile broadband communications system utilizing an orthogonal frequency-division multiple access technique, the fixed device having a precoding module operative to generate one or more precoding vectors for multiple mobile devices using a non-unitary precoding scheme for a closed loop multi-user multiple-input and multiple-output (MIMO) scheme, the precoding module to generate the one or more precoding vectors using channel state information comprising channel quality information and a codeword index received from each of the multiple mobile devices.

12. The apparatus of claim 11, comprising a radio operative to receive channel quality information and a codeword index from multiple mobile devices over an uplink wireless channel.

13. The apparatus of claim 11, comprising:
a scheduler operative to select a group of mobile devices from the multiple mobile devices; and
the precoding module operative to generate or adjust a precoding vector for the selected group of mobile devices.

14. The apparatus of claim 13, the scheduler operative to form candidate groups of mobile devices from the multiple mobile devices, estimate a sum rate for each candidate group of mobile devices, and select a candidate group of mobile devices having a highest sum rate as the group of mobile devices.

15. The apparatus of claim 13, the scheduler operative to select a first mobile device with a highest channel quality information, form candidate groups of mobile devices from the multiple mobile devices, with each candidate group having the first mobile device and at least a second mobile device, estimate a sum rate for each candidate group of mobile devices, and select a candidate group of mobile devices having a highest sum rate as the group of mobile devices.

16. The apparatus of claim 11, the precoding module operative to generate the one or more precoding vectors using a zero forcing or minimum mean square error algorithm.

17. The apparatus of claim 11, the radio operative to transmit the one or more precoding vectors to the selected group of mobile devices using control signals or reference signals.

18. A method, comprising:
receiving one or more reference signals over a downlink wireless channel by a mobile device from a fixed device;
estimating a channel matrix based on the one or more reference signals;
determining an effective channel based on the channel matrix;
selecting a codeword from a quantized codebook for the effective channel;
estimating channel quality information based on the selected codeword; and
sending the channel quality information and a codeword index over an uplink wireless channel from the mobile device to the fixed device.

19. The method of claim 18, the channel matrix comprising an instantaneous channel matrix for short-term channel state information.

20. The method of claim 18, the channel matrix comprising a channel correlation matrix for long-term channel state information.

21. The method of claim 18, comprising determining the effective channel using singular value decomposition.

22. The method of claim 18, comprising estimating the channel quality information without precoding vectors of other mobile devices.

23. The method of claim 18, comprising estimating the channel quality information as a physical signal-to-interference-and-noise ratio (SINR) of a minimum mean square error (MMSE) receiver by assuming the selected codeword is a precoding vector for the mobile device and a set of precoding vectors of other mobile devices are orthogonal to the precoding vector.

24. A method, comprising:
receiving channel quality information and a codeword index from multiple mobile devices over an uplink wireless channel by a fixed device;
selecting a group of mobile devices from the multiple mobile devices;
generating a precoding vector for the selected group of mobile devices; and
transmitting the precoding vector to the selected group of mobile devices.

25. The method of claim 24, comprising:
forming candidate groups of mobile devices from the multiple mobile devices;
estimating a sum rate for each candidate group of mobile devices; and
selecting a candidate group of mobile devices having a highest sum rate as the group of mobile devices.

26. The method of claim 24, comprising:
selecting a first mobile device with a highest channel quality information;
forming candidate groups of mobile devices from the multiple mobile devices, with each candidate group having the first mobile device and at least a second mobile device;
estimating a sum rate for each candidate group of mobile devices; and
selecting a candidate group of mobile devices having a highest sum rate as the group of mobile devices.

27. The method of claim 24, comprising generating the precoding vector using a zero forcing or minimum mean square error algorithm.

28. The method of claim 24, transmitting the precoding vector to the selected group of mobile devices using control signals or reference signals.

29. An article comprising a storage medium containing instructions that when executed enable a system to receive one or more reference signals over a downlink wireless channel by a mobile device from a fixed device, estimate a channel matrix based on the one or more reference signals, determine an effective channel based on the channel matrix, select a codeword from a quantized codebook for the effective channel, estimate channel quality information based on the selected codeword, and transmit the channel quality information and a codeword index over an uplink wireless channel from the mobile device to the fixed device.

30. The article of claim 29, further comprising instructions that when executed enable the system to estimate the channel matrix based on the one or more reference signals for the downlink wireless channel without precoding vectors of other mobile devices.
